(19) United States
(12) Patent Application Publication
(10) Pub. No.: US 2017/0169044 A1
(43) Pub. Date: Jun. 15, 2017

(54) PROPERTY RETRIEVAL APPARATUS, METHOD AND SYSTEM

(71) Applicants: LE HOLDINGS (BEIJING) CO., LTD., Beijing (CN); LE SHI INTERNET INFORMATION & TECHNOLOGY CORP., BEIJING, Beijing (CN)

(72) Inventor: Jiaxing ZHU, Beijing (CN)

(73) Assignees: LE HOLDINGS (BEIJING) CO., LTD., Beijing (CN); LE SHI INTERNET INFORMATION & TECHNOLOGY CORP., BEIJING, Beijing (CN)

(21) Appl. No.: 15/243,179

(22) Filed: Aug. 22, 2016

Related U.S. Application Data
(63) Continuation of application No. PCT/CN2016/089556, filed on Jul. 10, 2016.

(30) Foreign Application Priority Data
Dec. 15, 2015 (CN) 201510930307.6

(51) Int. Cl. G06F 17/30

(52) U.S. Cl. CPC G06F 17/30091; G06F 17/3002; G06F 17/30132

(57) ABSTRACT

Embodiments of the present disclosure disclose a method for media resource retrieval and an electronic device. where the method for media resource retrieval includes: receiving a retrieval instructions from a client; and extracting a keyword from the retrieval instructions, extracting, from an inverted index file according to the keyword, relevant information having the keyword, and feed back the information, as a retrieval result, to the client, wherein the inverted index file stores relevant information of a relevant media file. With the above technical solutions, all information of the relevant media file is pre-stored into the inverted index file, and after receiving the retrieval instructions from the client, the server may directly extract, from the inverted index file, information conforming to the retrieval instruction, and feed back the information to the client.

The present application is a continuation of PCT application No. PCT/CN2016/089556 submitted on Jul. 10, 2016. This application is based upon and claims priority to Chinese Patent Application No. 201510930307.6, filed before Chinese Patent Office on Dec. 15, 2015, the entire contents of which are incorporated herein by reference.

### TECHNICAL FIELD

The present disclosure relates to the field of information technologies, and more particularly, to a device, a method, and a system for media resource retrieval.

### BACKGROUND

With development of information technologies, there is an explosive rise in various types of entertainment image data, and the existing media asset management system stores a large quantity of media files (for example, videos, audio, or pictures). How to quickly find a file wanted by a user from the media asset management system has become a problem to be resolved in the industry.

In the existing media asset management system, media files are mainly stored in a server of the system. The user may send a retrieval request via a client (for example, a personal computer, a mobile phone, or a tablet computer). After receiving the retrieval request, the server extracts a keyword (for example, “Empresses in the Palace”) from the retrieval request, and extracts corresponding information from the stored media files by means of like matching. Because there is a quite large quantity of media files stored in the server, the speed of extracting corresponding information from the large quantity of the stored media files by means of like matching is very low, and the working load of the server is relatively great. As a result, the speed of responding to the retrieval request of the user is low, and the user experience is poor.

### SUMMARY

An objective of the present disclosure is to provide a device, a method, and a system for media resource retrieval, so that a server in a media asset management system can quickly find corresponding information after receiving a retrieval request from a client and feedback the corresponding information to the client, and a responding speed is relatively high.

According to a first aspect, an embodiment of the present disclosure provides an electronic device. The device includes: at least one processor; and a memory communicably connected with the at least one processor for storing instructions executable by the at least one processor, where execution of the instructions by the at least one processor causes the at least one processor to be capable of: receiving a retrieval instructions from a client; and extracting a keyword from the retrieval instructions, extracting, from a preset inverted index file according to the keyword, relevant information having the keyword, and feeding back the information, as a retrieval result, to the client, where the inverted index file stores relevant information of a relevant media file.

According to a second aspect, an embodiment of this disclosure further provides a method for media resource retrieval, including: receiving a retrieval instruction from a client; and extracting a keyword from the retrieval instructions, extracting, from a preset inverted index file according to the keyword, relevant information having the keyword, and feeding back the information, as a retrieval result, to the client, where the inverted index file stores relevant information of a relevant media file.

According to a third aspect, an embodiment of this disclosure further provides a non-volatile computer storage medium, which stores a computer executable instructions, where the computer executable instructions is used to execute any foregoing method for media resource retrieval of this disclosure.

### BRIEF DESCRIPTION OF THE DRAWINGS

The accompanying drawings are used to provide further understanding of embodiments of the present disclosure, to form a part of the specification. The accompanying drawings are used to explain the embodiments of the present disclosure together with the following specific implementation manners, but do not form a limitation to the embodiments of the present disclosure. In the accompanying drawings:

FIG. 1 is a schematic structural diagram illustrating an electronic device according to an embodiment of the present disclosure;

FIG. 2 is a flowchart of a method illustrating media resource retrieval according to an embodiment of the present disclosure; and

FIG. 3 is a schematic structural diagram of hardware of an electronic device for executing a method for media resource retrieval provided in an embodiment of this present disclosure.

### DETAILED DESCRIPTION

The following describes specific implementation manners of the present disclosure in detail with reference to the accompanying drawings. It should be understood that the specific implementation manners described herein are merely used for describing and explaining embodiments of the present disclosure, and are not used to limit the embodiments of the present disclosure.

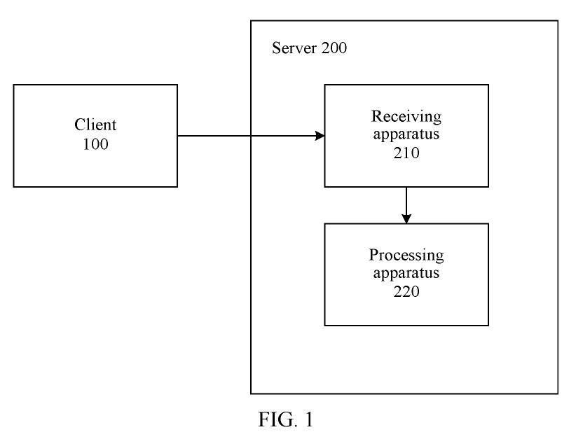

FIG. 1 is a schematic structural diagram illustrating an electronic device according to an embodiment of the present disclosure. As illustrated in FIG. 1, this embodiment of the present disclosure provides a system for media resource retrieval. The system includes: a client 100, configured to send a retrieval instruction; and a server 200, including the foregoing electronic device. The electronic device includes: a receiving apparatus 210, configured to receive the retrieval instruction from the client; and a processing apparatus 220, configured to: extract a keyword from the retrieval instruction, extract, from a preset inverted index file according to the keyword, relevant information (including for example, a media file name, a play platform, a payment platform, or a media file type) having the keyword, and feed back the information, as a retrieval result, to the client.

The inverted index file stores relevant information of a relevant media file. For example, the inverted index file may store an attribute value (for example, a file name, or a play platform) of a media file and an address of a media file having the attribute value. That is, each record in the inverted index file includes an attribute value and an address of each media file having the attribute value. A general data storage and retrieval manner is traversing each stored file to determine an attribute of the file, and comparing the attribute with a retrieval keyword, and this is time-consuming. With the solution according to this embodiment of the present disclosure, it is simple to find an attribute conforming to the retrieval keyword from all stored attribute values of media files, and determine an address of a media file having the attribute. Using a retrieval word “Empresses in the Palace” as an example, the processing apparatus may search the inverted index file, determine whether there is a media file with the media file name “Empresses in the Palace”, and feed back to the client according to a search result. In a case where there is a media file with the media file name “Empresses in the Palace”, an address of the media file may also be fed back to the client together, so that the client can access the media file. Using a retrieval word “MP4” as an example, the processing apparatus may search the inverted index file, determine whether there is a media file with the media file type “MP4”, and feed back to the client according to a search result. In a case where there is a media file with the media file type “MP4”, an address of the media file may also be fed back to the client together, so that the client can access the media file.

The preset inverted index file may be generated by the following operations: the receiving apparatus may receive a media file; and for each media file received by the receiving apparatus, the processing apparatus further extracts relevant information (i.e., an attribute value, for example, a media file name, a play platform, a payment platform, or a media file type) from the media file, and stores the information into the inverted index file. Nevertheless, an address of the media file is also stored in the inverted index file at the same time. It should be noted that the attribute value and relevant information are not limited to the above listed content, and may also be bit rate information of a media file, and the like. This embodiment of the present disclosure is not limited herein.

In an embodiment, the device may be a search platform based on an ElasticSearch technology, and the device may provide, as a node in a cluster for implementing a retrieval function, a retrieval result. The search platform based on the ElasticSearch technology can achieve the effects of real-time search, stability, reliability and fastness.

In an embodiment, the inverted index file may be stored in a cache of the processing apparatus. Because a data access speed in the cache is greater than a speed for accessing data on a hard disk, a retrieval speed may be further improved by means of the arrangement.

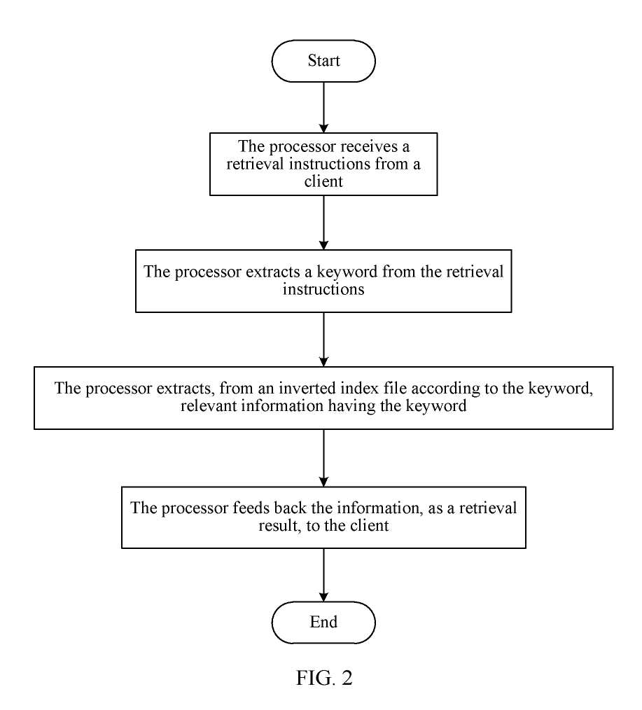

FIG. 2 is a flowchart illustrating a method according to an embodiment of the present disclosure. As illustrated in FIG. 2, this embodiment of the present disclosure further provides a method. The method includes: receiving retrieval instructions from a client; and extracting a keyword from the retrieval instructions, extracting, from a preset inverted index file according to the keyword, relevant information (including for example, a media file name, a play platform, a payment platform, or a media file type) having the keyword, and feeding back the information, as a retrieval result, to the client, where the inverted index file stores relevant information of a relevant media file. In this way, because all information of a relevant media file is pre-stored into the inverted media file, and different from a general file storage manner, each record in the inverted index file includes an attribute value and an address of each media file having the attribute value; after receiving the retrieval instruction from the client, the server may directly extract information conforming to the retrieval instruction from the inverted index file, and feed back the information to the client. As compared with the existing manner for matching media files by means of like matching, the manner in the present disclosure obviously improves the speed of retrieving media files, and mitigates a working load of the server.

The preset inverted index file may be generated by the following operations: receiving a media file; and extracting relevant information (i.e., an attribute value, for example, a media file name, a play platform, a payment platform, or a media file type) from the media file, and storing the information into the inverted index file. That is, each time the server stores a media file, the server extracts attribute information of the media file and stores the information into the inverted index file for a subsequent retrieval. Nevertheless, an address of the media file is also stored in the inverted index file at the same time. It should be noted that the attribute value and relevant information are not limited to the above listed content, and may also be bit rate information of a media file and the like. This embodiment of the present disclosure is not limited herein.

The method may be based on an Elastic Search technology, and the technology provides a retrieval result by using a cluster having a retrieval function, and may achieve the effects of real-time search, stability, reliability and fastness.

The inverted index file may be stored in a cache. Because a data access speed in the cache is greater than a speed for accessing data on a hard disk, a retrieval speed may be further improved by means of the arrangement.

With the above technical solutions, all information of a relevant media file is pre-stored into an inverted index file, and after receiving a retrieval instruction from the client, the server may directly extract, from the inverted index file, information conforming to the retrieval instruction, and feed back the information to the client. As compared with the existing manner for matching media files by means of like matching, the manner in the present disclosure obviously improves the speed of retrieving media files, and mitigates a working load of the server. In addition, from a technical perspective, because a media file includes information (for example, bit rate information) in many aspects, when a database of the server stores the information, in order to avoid generation of a medium table, many redundant fields are generated. However, after the solutions of the application are used, the information may be directly stored into the inverted index field, and the database does not need to be extended, thereby reducing pressure of the database storage capacity.

An implementation manner of this present disclosure further provides a non-volatile computer storage medium, which stores a computer executable instructions, where the computer executable instructions can execute the method for media resource retrieval in any one of the foregoing method embodiments.

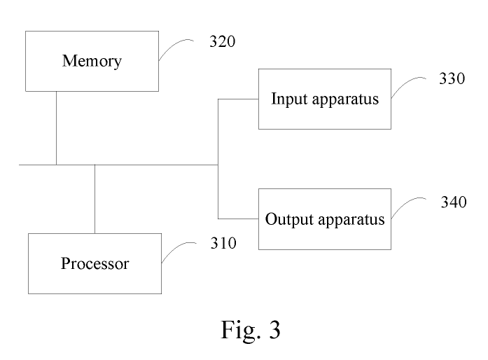

FIG. 3 is a schematic structural diagram of hardware of an electronic device for executing a method for media resource retrieval provided in an embodiment of this present disclosure. As shown in FIG. 3, the electronic device includes: one or more processors 310 and a memory 320, where only one processor 310 is used as an example in FIG. 3.

A device for executing the method for media resource retrieval may further include: an input apparatus 330 and an output apparatus 340.

The processor 310, the memory 320, the input apparatus 330, and the output apparatus 340 can be connected by means of a bus or in other manners. A connection by means of a bus is used as an example in FIG. 3.

Storage medium 320 is a non-transitory computer-readable medium for storing a non-transitory software program, a non-transitory computer-readable program and module, for example the program instructions/module for performing an above described method (for example, the receiving apparatus 210 and the processing apparatus 220 shown in FIG. 1). The processor 310 can operate the various functions and data processing of a server to perform the method for media resource retrieval described in the above embodiments by executing non-transitory software programs, instructions and modules stored in the storage medium 320.

The storage medium 320 can include a program storage area and a data storage area. Among them, the program storage area may store operation system, application programs of at least one function; the data storage area may store generated data during operation of the electronic apparatus for performing the method described in the above embodiments. In addition, the storage medium 320 may include a high speed random access memory, and a non-transitory storage medium, for example a magnetic storage device (e.g., hard disk, floppy disk, and magnetic strip), a flash memory device (e.g., card, stick, key drive) or other non-transitory solid state storage device. In some embodiments, the storage medium 320 may include a storage medium that is remote to the processor 310. The remote storage medium may be connected to the processing apparatus for media resource retrieval for performing any of the above methods by a network. The examples of such as network include but not limited to Internet, enterprise intranet, local area network, mobile telecommunication network and a combination thereof.

The input apparatus 330 can receive input number or byte information, and can generate input key information relating to user setting and functional control of the processing apparatus for media resource retrieval. The output apparatus 340 may include a display device such as a display screen.

The one or more modules stored in the storage medium 320 that, when executed by the one or more processors 310, can perform the method for media resource retrieval in any of the above described methods.

The above products can perform any of the above described methods, and have corresponding functional modules and effects. Details that are not disclosed in this embodiment can be understood by reference to the above method embodiments of the present disclosure.

An electronic apparatus of the present disclosure can exist in a varied form and includes but not limited to:

(1) A mobile communication device which is capable of performing mobile communication function and having a main purpose for audio or data communication. Such a mobile communication device includes: a smart phone (e.g. iPhone), a multimedia phone, a functional mobile phone and a low-end mobile phone etc.

(2) A super-mobile personal computer which belongs to the field of a personal computer and has calculation and processing functions, and in general can access to a mobile network. Such a terminal device includes: a PDA, a MID and a UMPC etc., for example iPad.

(3) A portable entertainment device which is capable of displaying and playing multimedia content. Such a device includes: an audio player, a video player (e.g. iPod), a handheld game console, an electronic book, a smart toy and a portable automotive navigation device.

(4) A server which can provide calculation service and can include a processor, a hard disk, a memory, a system bus etc. Such a server is similar to a general computer in terms of a computer structure, but is necessary to provide reliable service, which therefore requires a higher standard in certain aspects such as data processing, stability, reliability, security and compatibility and manageability etc.

(5) Other electronic apparatus that is capable of data exchange.

The above described apparatus embodiments are for illustration purpose only, in which modules/units that are described above as separate elements may be physically separate or not separate and modules/units that are described above as display elements may be or may not be a physical unit, i.e. in a same location or in various distributed network units. The skilled person in this field can understand that it is possible to select some or all of the units or modules to achieve the purpose of the embodiment.

According to the above description, the skilled person in this field can understand that various embodiments can be implemented by software over a general hardware platform or by hardware. Accordingly, the above technical solution or what is contributed to the prior art may be implemented in the form of software product. The computer software product may be stored in a computer-readable storage medium, for example random access memory (RAM), read only memory (ROM), compact disk (CD), digital versatile disk (DVD) etc. which includes instructions for causing a computing device (e.g. a personal computer, a server or a network device etc.) to perform a method of some or all parts of any one of the above described embodiments.

Finally, it should be noted that the previous embodiments are provided to enable any person skilled in the art to practice the various embodiments of the present disclosure described herein but not to limit these aspects. Though the present disclosure is described by reference to the previous embodiments, various modifications and equivalent features will be readily apparent to those skilled in the art without departing from the spirit and scope of the present disclosure, and the generic principles defined herein may be applied to other aspects or with equivalent features. Thus, the claims are not intended to be limited to the aspects and features shown herein, but are to be accorded the full scope consistent with the language of the claims.

What is claimed is:

1. An electronic device, comprising:
at least one processor; and
a memory communicably connected with the at least one processor
for storing instructions executable by the at least one processor, wherein execution of the instructions by the at least one processor causes the at least one processor to be capable of:
receiving a retrieval instruction from a client; and
extracting a keyword from the retrieval instructions, extracting, from a preset inverted index file according to the keyword, relevant information having the keyword, and feeding back the information, as a retrieval result, to the client, where the inverted index file stores relevant information of a relevant media file.

2. The device according to claim 1, wherein the relevant information comprises one or more of: a media file name, a play platform, a payment platform, and a media file type.

3. The device according to claim 1, wherein the processor is further capable of:
receive a media file; and
extract relevant information from the media file, and store the information into the inverted index file.

4. The device according to claims 1, wherein the inverted index file is stored in a cache of the processing apparatus.

5. A method , comprising:
receiving a retrieval instructions from a client; and
extracting a keyword from the retrieval instructions, extracting, from a preset inverted index file according to the keyword, relevant information having the keyword, and feeding back the information, as a retrieval result, to the client, wherein the inverted index file stores relevant information of a relevant media file.

6. The method according to claim 5, wherein the relevant information comprises one or more of: a media file name, a play platform, a payment platform, and a media file type.

7. The method according to claim 5, wherein the method further comprises:
receiving a media file; and
extracting relevant information from the media file and storing the information into the inverted index file.

8. The method according to any one of claims 5, wherein the inverted index file is stored in a cache.

9. A non-transitory computer storage medium, which stores computer executable instructions that, when executed by an electronic device, cause the electronic device to:
receive a retrieval instructions from a client; and
extract a keyword from the retrieval instructions, extracting, from a preset inverted index file according to the keyword, relevant information having the keyword, and feeding back the information, as a retrieval result, to the client, wherein the inverted index file stores relevant information of a relevant media file.

10. The non-transitory computer storage medium according to claim 9, wherein the relevant information comprises one or more of the following: a media file name, a play platform, a payment platform, and a media file type.

11. The non-transitory computer storage medium according to claim 9, wherein the computer executable instructions that, when executed by an electronic device, cause the electronic device to:
receive a media file; and
extract relevant information from the media file and storing the information into the inverted index file.

12. The non-transitory computer storage medium according to claim 9, wherein the inverted index file is stored in a cache.
